(19) United States
(12) Patent Application Publication
(10) Pub. No.: US 2015/0048904 A1
(43) Pub. Date: Feb. 19, 2015

(54) Resonance Tube, Method for Manufacturing Resonance Tube, and Cavity Filter

(71) Applicant: Huawei Technologies Co., Ltd., Shenzhen (CN)

(72) Inventors: Yanzhao Zhou, Milano (IT); Liang Yuan, Shenzhen (CN)

(21) Appl. No.: 14/481,184

(22) Filed: Sep. 9, 2014

Related U.S. Application Data
(63) Continuation of application No. PCT/CN2012/082398, filed on Sep. 28, 2012.

(30) Foreign Application Priority Data
Mar. 13, 2012 (CN) 201210064744.0

(51) Int. Cl. H01P 1/207; C25D 7/04; B22F 3/12; B22F 5/10; B22F 3/26; B22F 3/10

(52) U.S. Cl. CPC H01P 7/00; H01P 1/207; B22F 3/26; B22F 3/1007; B22F 3/12; B22F 5/106; C25D 7/04; B22F 2201/20; B22F 2301/35; B22F 2302/45
USPC 333/203; 419/5; 333/223

(57) ABSTRACT

A resonance tube, a method for manufacturing a resonance tube, and a cavity filter, which relate to the field of communications devices and can provide a temperature compensation effect of different degrees, reduce a production cost, and improve production efficiency. The resonance tube is manufactured using powder materials, and the powder materials include at least one of carbonyl iron powder and iron powder and at least one of carbonyl nickel powder and nickel powder, a mass percentage of the at least one of carbonyl iron powder and iron powder in the powder materials is 58-70%, and a mass percentage of the at least one of carbonyl nickel powder and nickel powder in the powder materials is 30-42%. The present invention may be used on a communications device, for example, a base station.

### CROSS-REFERENCE TO RELATED APPLICATIONS

This application is a continuation of International Application No. PCT/CN 2012/082398, filed on Sep. 28, 2012, which claims priority to Chinese Patent Application No. 201210064744.0, filed on Mar. 13, 2012, both of which are hereby incorporated by reference in their entireties.

### TECHNICAL FIELD

The present invention relates to the field of communications devices, and in particular, to a resonance tube, a method for manufacturing a resonance tube, and a cavity filter.

### BACKGROUND

A duplexer of a base station transceiver module is formed of a radio frequency cavity filter and is used for transmitting a single-path high-power signal. A cavity filter includes parts such as a tuning screw, a resonance tube, and a cavity. Due to a thermal expansion property of a material, resonance frequency of a cavity filter varies with temperature, and therefore a filtering property of a cavity filter varies with temperature. Such a phenomenon is called a temperature drift. The temperature drift degrades a radio frequency index, and causes performance declination of a cavity filter.

Currently, a temperature drift problem of a cavity filter is solved by a temperature compensation effect of parts of the cavity filter. Changes to the parts of the cavity filter caused by thermal expansion have different impacts on resonance frequency of the cavity filter. As temperature rises, an impact of some parts on the resonance frequency causes a decrease in the resonance frequency, whereas an impact of some other parts on the resonance frequency causes an increase in the resonance frequency. In this way, the decrease and the increase in the resonance frequency offset each other, and therefore temperature compensation of the cavity filter can be implemented using this law of change, thereby solving the temperature drift problem of the cavity filter.

During a process of implementing the temperature compensation, the inventor finds that the prior art has at least the following problem.

In the prior art, a material of a resonance tube of a cavity filter may be free cutting steel, a brass material, an invar material, and the like, where linear expansion coefficients of the free cutting steel, the brass material, and the invar material are 12 parts per million per degree Celsius (ppm/° C.), 18.4 ppm/° C., and 0.9 ppm/° C. respectively. It can be seen that the linear expansion coefficients thereof are all constant, and are significantly different from each other. No matter what material a resonance tube is made of, temperature compensation of a corresponding degree is provided only corresponding to a constant linear expansion coefficient of this material. Therefore, only the foregoing several linear expansion coefficients are optional for a resonance tube in the prior art, and resonance tubes made of materials with different linear expansion coefficients cannot be provided according to an actual temperature compensation requirement. In addition, in the prior art, a resonance tube is manufactured using a conventional machining processing technique, and a radio frequency index cannot be met and a processing cost is high for some duplexers with a high requirement for a temperature drift and a degree of out-of-band suppression, especially a metal resonance tube made of an invar material. This metal resonance tube is manufactured using a special formula, manufacturing process, and heat processing process, and is very high in cost.

### SUMMARY

Embodiments of the present invention provide a resonance tube, a method for manufacturing a resonance tube, and a cavity filter, so as to provide a temperature compensation effect of different degrees, reduce a production cost, and improve production efficiency.

To achieve the foregoing objectives, the embodiments of the present invention adopt the following technical solutions:

A resonance tube is manufactured using powder materials, and the powder materials include at least one of carbonyl iron powder and iron powder and at least one of carbonyl nickel powder and nickel powder, where a mass percentage of the at least one of carbonyl iron powder and iron powder in the powder materials is 58-70%, and a mass percentage of the at least one of carbonyl nickel powder and nickel powder in the powder materials is 30-42%.

A method for manufacturing a resonance tube provided by an embodiment of the present invention includes performing mixing processing on the powder materials; making powder materials that are obtained after the mixing processing into granules; performing injection molding on the granules to form a resonance tube blank; performing vacuum sintering on the resonance tube blank to form a semi-finished resonance tube; and performing electroplating processing on the semi-finished resonance tube to form the resonance tube.

A cavity filter includes at least one resonance tube provided by the embodiment of the present invention and at least one tuning apparatus disposed above the resonance tube.

According to the resonance tube, the method for manufacturing a resonance tube, and the cavity filter provided by the embodiments of the present invention, a resonance tube is manufactured using at least one of carbonyl iron powder and iron powder and at least one of carbonyl nickel powder and nickel powder, and the resonance tube manufactured in this way may have different linear expansion coefficients according to powder materials that are used and proportioning of the powder materials, thereby providing a temperature compensation effect of different degrees for a cavity filter, and has desirable applicability. An injection molding method that is used can further significantly reduce a production cost and improve production efficiency.

### BRIEF DESCRIPTION OF DRAWINGS

To describe the technical solutions in the embodiments of the present invention or in the prior art more clearly, the following briefly introduces the accompanying drawings required for describing the embodiments or the prior art. The accompanying drawings in the following description show merely some embodiments of the present invention, and a person of ordinary skill in the art may still derive other drawings from these accompanying drawings without creative efforts.

FIG. 1 is a schematic diagram of a physical model of a cavity filter in the prior art;

FIG. 2 is a flowchart of a method for manufacturing a resonance tube according to an embodiment of the present invention;

FIG. 3 is a schematic diagram of a physical model of a cavity filter according to an embodiment of the present invention;

FIG. 4 is a flowchart of a method for manufacturing a resonance tube according to an embodiment of the present invention;

FIG. 5 is a flowchart of a method for manufacturing a resonance tube according to another embodiment of the present invention;

FIG. 6 is a flowchart of a method for manufacturing a resonance tube according to another embodiment of the present invention;

FIG. 7 is a test diagram of a physical size of the resonance tube in FIG. 4 at different temperatures;

FIG. 8 is a test diagram of a physical size of the resonance tube in FIG. 5 at different temperatures; and

FIG. 9 is a test diagram of a physical size of the resonance tube in FIG. 6 at different temperatures.

### DESCRIPTION OF EMBODIMENTS

The following clearly describes the technical solutions in the embodiments of the present invention with reference to the accompanying drawings in the embodiments of the present invention. The described embodiments are merely a part rather than all of the embodiments of the present invention. All other embodiments obtained by a person of ordinary skill in the art based on the embodiments of the present invention without creative efforts shall fall within the protection scope of the present invention.

To better describe a resonance tube provided by an embodiment of the present invention to help a person skilled in the art better understand the technical solutions adopted by the present invention, a temperature compensation process of the resonance tube that is in a cavity filter is briefly described using a physical model of the cavity filter shown in FIG. 1 as an example.

As shown in FIG. 1, a cavity filter includes a tuning screw 1, a resonance tube 2, and a cavity 3, where an inner cavity 4 is formed inside the resonance tube 2, and an outer cavity 5 is formed inside the cavity 3. Changes to the parts of the cavity filter caused by thermal expansion have different impacts on resonance frequency of the cavity filter. For example, as temperature rises, an impact of an increase in a height of the resonance tube 2 on the resonance frequency causes a decrease in the resonance frequency, whereas an impact of an increase in a height of the cavity 3 on the resonance frequency causes an increase in the resonance frequency. In this way, the increase and the decrease in the resonance frequency may offset each other, and therefore the temperature compensation process can be implemented using this contrary law of change. Experimental data indicates that a frequency offset of a cavity filter after temperature compensation decreases a lot compared with that of a cavity filter that has not undergone temperature compensation. However, a linear expansion coefficient of a material for manufacturing a resonance tube is constant, and therefore a temperature compensation effect of the resonance tube is limited and not flexible. Based on the temperature compensation process of a resonance tube that is in a cavity filter, the following describes, in detail, a resonance tube provided by the embodiment of the present invention.

An embodiment of the present invention provides a resonance tube, where the resonance tube is manufactured using powder materials, the powder materials include at least one of carbonyl iron powder and iron powder and at least one of carbonyl nickel powder and nickel powder, where a mass percentage of the at least one of carbonyl iron powder and iron powder in the powder materials is 58-70%, and a mass percentage of the at least one of carbonyl nickel powder and nickel powder in the powder materials is 30-42%.

A powder material refers to a granule material of certain granularity. A granularity size of a powder material is generally from a nanometer scale to a millimeter scale; and according to the granularity size, a powder material may be categorized into nanometer powder, ultra micro powder, micro powder, fine powder, coarse powder, and the like. Compared with a granule of a large size or a block-shaped material, a powder material has an advantage such as having a larger surface area, higher surface energy, and higher surface activity. The resonance tube is manufactured using the at least one of carbonyl iron powder and iron powder and the at least one of carbonyl nickel powder and nickel powder. Preferably, carbonyl cobalt powder can be added to the powder materials for manufacturing the resonance tube, which is certainly not limited by the present invention. It may be understood that, in a manufacturing process, only at least two of the foregoing powder materials may be used according to an actual case; and certainly another additive that can help with formation may also be added. A person skilled in the art may add a required addictive and the like according to common knowledge or common technical means in the art, which is not limited in the embodiment of the present invention.

The resonance tube provided by the embodiment of the present invention is manufactured using the at least one of carbonyl iron powder and iron powder and the at least one of carbonyl nickel powder and nickel powder; and the resonance tube manufactured in this way may have different linear expansion coefficients according to the at least two powder materials that are used and proportioning of the at least two powder materials, thereby providing a temperature compensation effect of different degrees for a cavity filter, and has desirable applicability. According to the resonance tube manufactured using powder materials, a production cost can be further significantly reduced, and production efficiency is improved.

Further, to ensure quality of the resonance tube, in the embodiment of the present invention, granularity distribution of the powder materials for manufacturing the resonance tube is mass of a powder material whose granule diameter is less than 2 micrometer (μm) is less than 10%; mass of a powder material whose granule diameter is 2-10 μm is greater than 80%; and mass of a powder material whose granule diameter is greater than 10 μm is less than 10%.

It should be noted that the granularity distribution of the powder materials refers to overall granularity distribution of the at least two powder materials for manufacturing the resonance tube. For example, when the powder materials for manufacturing the resonance tube are carbonyl iron powder and carbonyl nickel powder, the overall granularity distribution of the powder materials formed by the carbonyl iron powder and the carbonyl nickel powder is mass of a powder material whose granule diameter is less than 2μm is less than 10%; mass of a powder material whose granule diameter is 2-10 μm is greater than 80%; and mass of a powder material whose granule diameter is greater than 10 μm is less than 10%. Further, the granularity distribution of the at least two powder materials for manufacturing the resonance tube may also meet the foregoing granularity distribution. For example, when the powder materials for manufacturing the resonance tube are iron powder and nickel powder, the granularity distribution of the iron powder and the granularity distribution of the nickel powder are mass of a powder material whose granule diameter is less than 2 μm is less than 10%; mass of a powder material whose granule diameter is 2-10 μm is greater than 80%; and mass of a powder material whose granule diameter is greater than 10 μm is less than 10%.

The resonance tube is manufactured using the powder materials in which mass of a powder material of medium granularity is greater than 80%, so as to ensure uniformity of granularity of the powder materials and further improve the quality of the resonance tube; a product appearance with better surface smoothness can be achieved using a powder material of smaller granularity. It may be understood that a person skilled in the art can further choose powder materials of another granularity distribution according to common knowledge or common technical means in the art, which is not limited in the embodiment of the present invention.

Preferably, in an embodiment provided by the present invention, the powder materials for manufacturing the resonance tube include carbonyl iron powder and carbonyl nickel powder. The powder materials for manufacturing the resonance tube may include only hydroxyl iron powder and carbonyl iron powder, and on a precondition that hydroxyl iron powder and carbonyl iron powder are included, may also be used in combination with one or more of carbonyl cobalt powder, iron powder, and nickel powder. Preferably, in the embodiment of the present invention, mass percentages of carbonyl iron powder and carbonyl nickel powder in the powder materials for manufacturing the resonance tube are 58-70% and 30-42% respectively.

Carbonyl iron powder and carbonyl nickel powder have features such as high purity, even granularity, and easy formation. Therefore, the resonance tube manufactured using the powder materials that include hydroxyl iron powder and carbonyl iron powder has good performance. According to the powder materials that are used and proportioning of the powder materials, a linear expansion coefficient in a desired range can be provided, thereby providing a desired temperature compensation effect in the cavity filter. It may be understood that the foregoing example is for better describing the at least two powder materials in the embodiment of the present invention; and the resonance tube provided by the embodiment of the present invention can be manufactured using any two or more powder materials among carbonyl iron powder, carbonyl nickel powder, carbonyl cobalt powder, nickel powder, and iron powder, which is not limited in the embodiment of the present invention.

Further, in an embodiment provided by the present invention, a surface of the resonance tube is electroplated with a copper layer, and thickness of the copper layer is greater than 5 μm. Certainly, the embodiment of the present invention does not limit specific thickness of the copper layer. In an embodiment provided by the present invention, a surface of the resonance tube may be further electroplated with a silver layer, and thickness of the silver layer may be 3-5 μm. Similarly, the embodiment of the present invention does not limit specific thickness of the silver layer. A person skilled in the art may limit the thickness of the copper layer and the thickness of the silver layer according to common knowledge or common technical means in the art.

For a resonance tube that is electroplated with a copper layer or electroplated with both a copper layer and a silver layer, performance such as antioxidation, anticorrosion, and electrical conductivity of the resonance tube is improved, and appearance is enhanced.

Further, in an embodiment provided by the present invention, a linear expansion coefficient of the resonance tube is 0.9-12 ppm/° C., which addresses a lack of a resonator with a linear expansion coefficient of 0.9-12 ppm/° C. in the prior art.

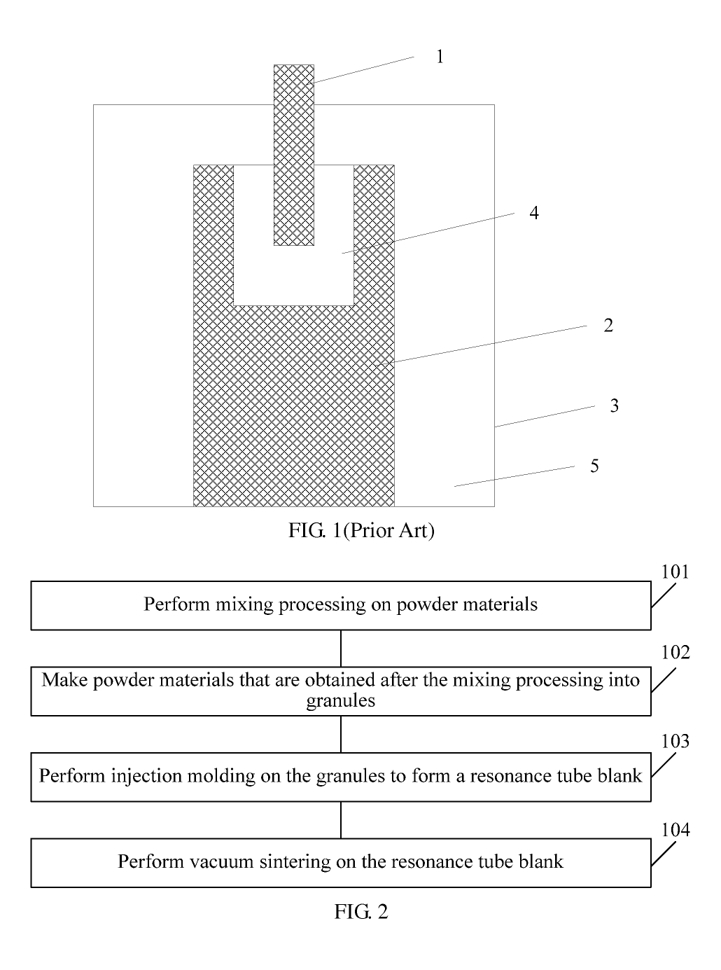

Accordingly, an embodiment of the present invention further provides a method for manufacturing the resonance tube. As shown in FIG. 2, the method includes:

101: Perform mixing processing on the powder materials.

The powder materials are the powder materials for manufacturing the resonance tube in the foregoing embodiment of the present invention, and include at least one of carbonyl iron powder and iron powder and at least one of carbonyl nickel powder and nickel powder, where the mass percentage of the at least one of carbonyl iron powder and iron powder in the powder materials is 58-70% and the mass percentage of the at least one of carbonyl nickel powder and nickel powder in the powder materials is 30-42%.

Further, in this step, the powder materials are mixed, and then an adhesive is added for mixing. Certainly, this is not limited in the embodiment of the present invention, and a person skilled in the art can determine whether to add an adhesive according to common knowledge or common technical means in the art.

It should be noted that the effect of adding an adhesive is to agglutinate metal powder to form the powder materials and the adhesive into a paste mixture, and make the paste mixture have a rheological property and a lubricating property; that is, the adhesive added herein is a carrier that trail the powder materials to flow, so as to facilitate a subsequent operation. Preferably, the adhesive includes polypropylene and paraffin wax. Certainly, a person skilled in the art can choose an appropriate adhesive according to the powder materials that are used and other factors, which is not limited in the embodiment of the present invention.

Preferably, the mass percentages of the powder materials and the adhesive are 60-90% and 10-40% respectively. A person skilled in the art can determine the mass percentages of the powder materials and the adhesive according to common knowledge or common technical means in the art.

102: Make powder materials that are obtained after the mixing processing into granules.

Further, in this step, the powder materials that are obtained after the mixing processing are made into bar-shaped or columnar granules. Certainly, the powder materials may also be made into granules in other shapes; and the embodiment of the present invention does not limit the shapes of the made granules. In step 102, the granules may be made in a granulator, which is not limited in the embodiment of the present invention.

Preferably, in this step, under a condition that an operating temperature is 150-300° C. and an operating pressure is 5-10 mega Pascal (MPa), the powder materials that are obtained after the mixing processing are made into granules. In the embodiment of the present invention, the specific operating temperature and operating pressure under which the granules are made are not limited, and may be determined by a person skilled in the art according to common knowledge and common technical means in the art.

103: Perform injection molding on the granules to form a resonance tube blank.

Further, in this step, injection molding may be performed in an injection molding machine. Certainly, in the embodiment of the present invention, a specific means for injection molding is not limited, and may be chosen by a person skilled in the art according to common knowledge and common technical means in the art.

Preferably, in this step, under a condition that an operating temperature is 200-300° C. and an operating pressure is 40-50 MPa, injection molding is performed on the granules. In the embodiment of the present invention, the operating temperature and operating pressure under which injection molding is performed on the granules are not limited, and may be determined by a person skilled in the art according to common knowledge and common technical means in the art.

104: Perform vacuum sintering on the resonance tube blank.

Preferably, in this step, the resonance tube blank is degreased first, and then the vacuum sintering is performed to obtain the resonance tube. Degreasing is to remove organic ingredients, for example, the adhesive, from a blank, so that the manufactured resonance tube has a compact metal composition.

Further, in this step, the vacuum sintering is performed on the resonance tube blank at a sintering temperature of 1300-1350° C. In the embodiment of the present invention, the temperature of the vacuum sintering on the resonance tube blank is not limited, and may be determined by a person skilled in the art according to common knowledge and common technical means in the art.

In the method for manufacturing a resonance tube provided by the embodiment of the present invention, the resonance tube is manufactured using at least one of carbonyl iron powder and iron powder and at least one of carbonyl nickel powder and nickel powder. When the resonance tube is manufactured using this method, the resonance tube may have different linear expansion coefficients according to powder materials that are used and proportioning of the powder materials, thereby providing a temperature compensation effect of different degrees for a cavity filter, so that the resonance tube has desirable applicability. The resonance tube provided by the embodiment of the present invention adopts a powder injection molding technology, which can reduce a loss of a raw metal material caused by a conventional metal processing process, greatly reduce production cost of the resonance tube, and also improve production efficiency.

Preferably, in an embodiment of the present invention, after step 104, the method further includes:

Perform electroplating processing on a resonance tube blank that is obtained after the vacuum sintering.

Further, this step includes:

Perform copper electroplating and then silver electroplating on the resonance tube blank that is obtained after the vacuum sintering. Preferably, thickness of an electroplated copper layer is greater than 5 μm, and thickness of an electroplated silver layer is 3-5 μm. Certainly, in the embodiment of the present invention, thickness of an electroplating layer is not limited, and a person skilled in the art may limit thickness of a copper layer and a silver layer according to common knowledge or common technical means in the art. After the resonance tube is electroplated, performance such as antioxidation, anticorrosion, and electrical conductivity of the resonance tube is improved, and appearance is enhanced.

A person of ordinary skill in the art may understand that all or a part of the processes of the method embodiment may be implemented by a computer program instructing relevant hardware. The program may be stored in a computer readable storage medium. When the program runs, the processes of the method embodiment are performed. The storage medium may be a magnetic disk, an optical disc, a read-only memory (ROM), a random access memory (RAM), or the like.

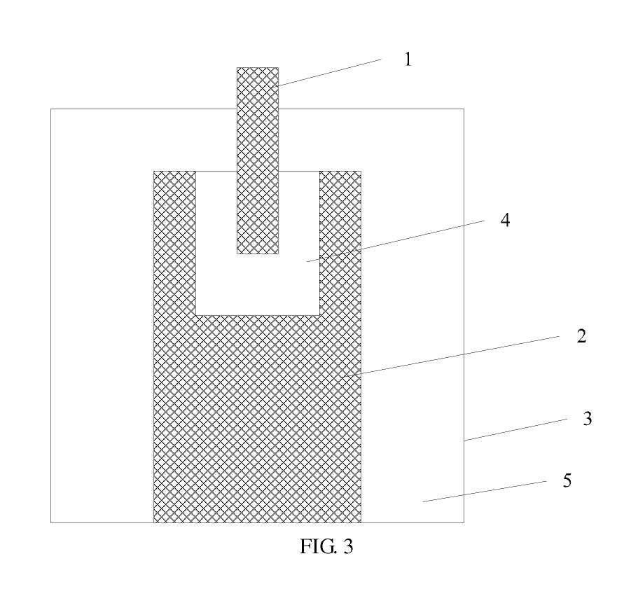

In addition, accordingly, an embodiment of the present invention further provides a cavity filter. As shown in FIG. 3, the cavity filter includes a tuning apparatus 1, a resonance tube 2, and a cavity 3, where the resonance tube 2 is the resonance tube according to any one of claims 1 to 10; an inner cavity 4 is formed inside the resonance tube 2, and an outer cavity 5 is formed inside the cavity 3; and the tuning apparatus 1 is located in the inner cavity 4, and the resonance tube 2 is located in the outer cavity 5. Optionally, the tuning apparatus 1 may be a tuning screw, which is certainly not limited in the embodiment of the present invention.

The cavity filter in the embodiment of the present invention is manufactured using the resonance tube provided by the present invention, and can achieve effects of reducing a temperature drift and improving a function of a radio frequency system, and reduce a production cost and improve production efficiency of a cavity filter.

To better describe the resonance tube, the method for manufacturing a resonance tube. and the cavity filter provided by the embodiments of the present invention, the following provides a detailed description using embodiments.

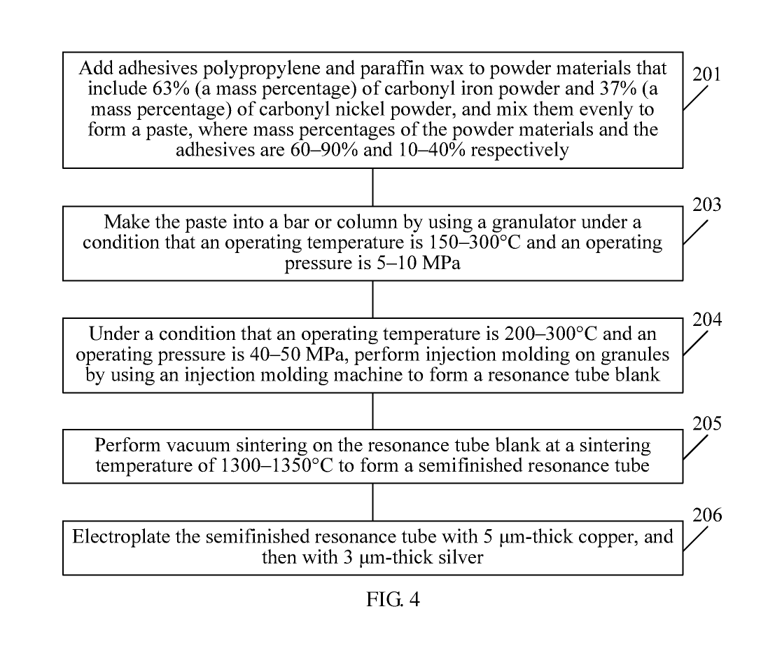

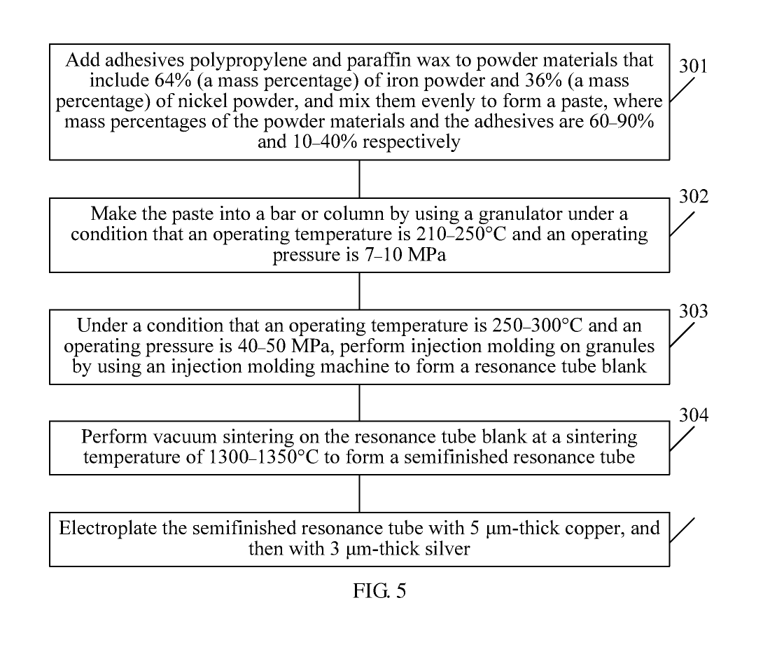

Embodiment 1 is a method for manufacturing a resonance tube to be used in a cavity filter for an Long Term Evolution (LTE) frequency band (2315-2375 megahertz (MHz)). As shown in FIG. 4, the method includes:

201: Add adhesives polypropylene and paraffin wax to powder materials that include 63% (a mass percentage) of carbonyl iron powder and 37% (a mass percentage) of carbonyl nickel powder, and mix them evenly to form a paste, where mass percentages of the powder materials and the adhesives are 60-90% and 10-40% respectively.

203: Make the paste into a bar or column using a granulator under a condition that an operating temperature is 150-300° C. and an operating pressure is 5-10 MPa.

204: Under a condition that an operating temperature is 200-300° C. and an operating pressure is 40-50 MPa, perform injection molding on the granules using an injection molding machine to form a resonance tube blank.

Preferably, after the injection molding is completed, wait 3 seconds before opening a mold.

205: Perform vacuum sintering on the resonance tube blank at a sintering temperature of 1300-1350° C. to form a semi-finished resonance tube.

206: Electroplate the semi-finished resonance tube with 5 μm-thick copper, and then with 3 μm-thick silver.

Preferably, copper electroplating and silver electroplating are performed using an electroplating method.

The resonance tube made in the foregoing steps is labeled A.

Embodiment 2 is a method for manufacturing a resonance tube to be used in a filter with a bandwidth of 20 MHz for 2.5 gigahertz (GHz) Worldwide Interoperability for Microwave Access (WiMax). As shown in FIG. 5, the method includes:

301: Add adhesives polypropylene and paraffin wax to powder materials that include 64% (a mass percentage) of iron powder and 36% (a mass percentage) of nickel powder, and mix them evenly to form a paste, where mass percentages of the powder materials and the adhesives are 60-90% and 10-40% respectively.

302: Make the paste into a bar or column using a granulator under a condition that an operating temperature is 210-250° C. and an operating pressure is 7-10 MPa.

303: Under a condition that an operating temperature is 250-300° C. and an operating pressure is 40-50 MPa, perform injection molding on the granules using an injection molding machine to form a resonance tube blank.

Preferably, after the injection molding is completed, wait 3 seconds before opening a mold.

304: Perform vacuum sintering on the resonance tube blank at a sintering temperature of 1300-1350° C. to form a semi-finished resonance tube.

305: Electroplate the semi-finished resonance tube with 5 μm-thick copper, and then with 3 μm-thick silver.

Preferably, copper electroplating and silver electroplating are performed using an electroplating method.

The resonance tube that is made in the foregoing steps is labeled B.

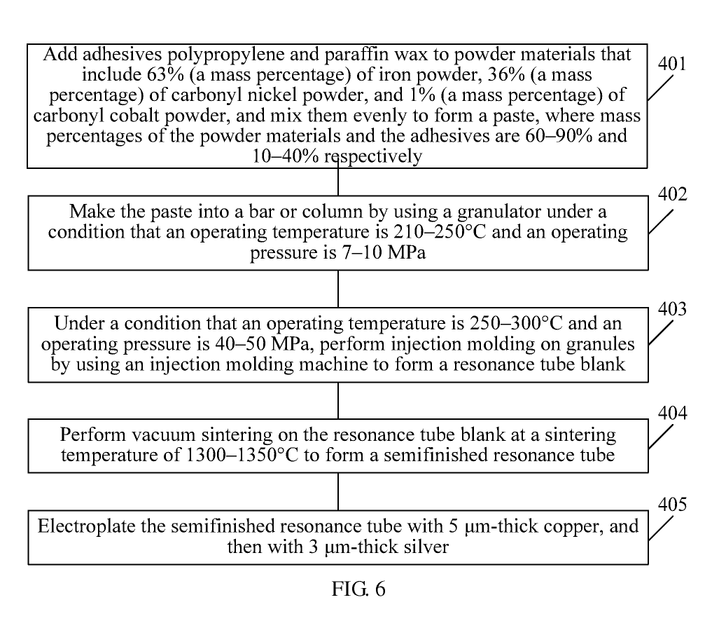

Embodiment 3 is a method for manufacturing a resonance tube to be used in a filter with a bandwidth of 15 MHz for 2.0 GHz Time Division Duplex (TDD). As shown in FIG. 6, the method includes:

401: Add adhesives polypropylene and paraffin wax to powder materials that include 63% (mass percentage) of iron powder, 36% (mass percentage) of carbonyl nickel powder, and 1% of carbonyl cobalt powder, and mix them evenly to form a paste, in which mass percentages of the powder materials and the adhesive are 60-90% and 10-40% respectively.

402: Make the paste into a bars or column using a granulator under a condition that an operating temperature is 210-250° C. and an operating pressure is 7-10 MPa.

403: Under a condition that an operating temperature is 250-300° C. and an operating pressure is 40-50 MPa, perform injection molding on the granules using an injection molding machine to form a resonance tube blank.

Preferably, after the injection molding is completed, wait 3 seconds before opening a mold.

404: Perform vacuum sintering on the resonance tube blank at a sintering temperature of 1300-1350° C. to form a semi-finished resonance tube.

405: Electroplate the semi-finished resonance tube with 5 μm-thick copper, and then with 3 μm-thick silver.

Preferably, copper electroplating and silver electroplating are performed using an electroplating method.

The resonance tube that is made in the foregoing steps is labeled C.

The following performs a Coefficient of Thermal Expansion, linear expansion coefficient (CTE) test on the resonance tubes A, B, and C that are manufactured according to the foregoing three embodiments. A exemplary process is as follows:

(1) Test physical sizes of the resonance tubes A, B, and C at a temperature of −40° C. to 85° C.

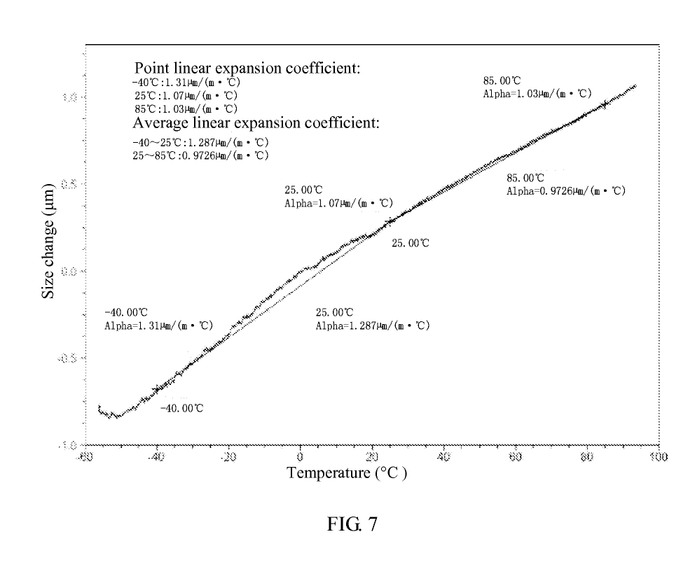

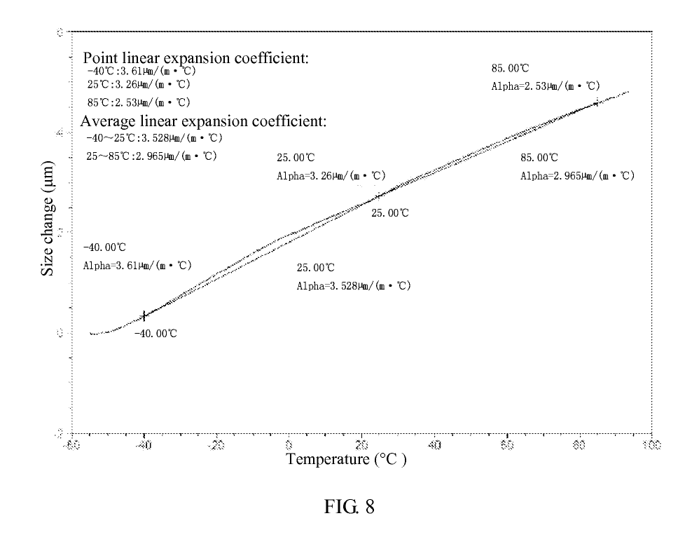

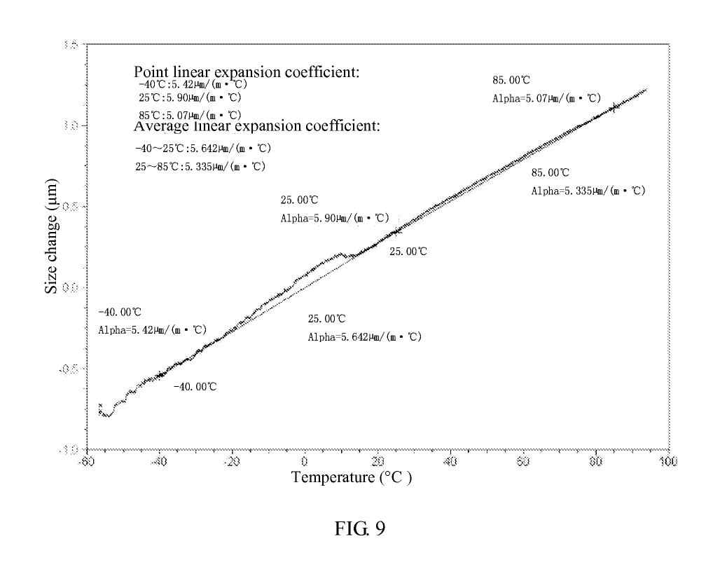

FIG. 7, FIG. 8, and FIG. 9 are diagrams separately describing tests of the physical sizes of the resonance tubes A, B, and C at different temperatures.

(2) Calculate linear expansion coefficients of the resonance tubes A, B, and C according to the physical sizes at different temperatures.

Alpha in the diagrams represents a linear expansion coefficient of a resonance tube.

A test result is a linear expansion coefficient of the resonance tube A is 1.0 ppm/° C.; a linear expansion coefficient of the resonance tube B is 3.2 ppm/° C.; and a linear expansion coefficient of the resonance tube C is 4.5-6.0 ppm/° C.

The test result indicates that the resonance tube A has a linear expansion coefficient of 1.0 ppm/° C., which is a low linear expansion coefficient, and may replace an invar resonator whose linear expansion coefficient is 0.9 ppm/° C. in the prior art; the resonance tube B has a linear expansion coefficient of 3.2 ppm/° C., which is slightly greater than that of an invar resonance tube, and can solve a problem of excessive temperature compensation of the invar resonance tube; and the resonance tube C has a linear expansion coefficient of 4.5-6.0 ppm/° C., which is a medium expansion coefficient, and can address a lack of a resonator with a linear expansion coefficient of 4.5-6.0 ppm/° C. in the prior art.

Further, a test indicates that a resonance tube that is manufactured using powder materials that include carbonyl iron powder and carbonyl nickel powder has a linear expansion coefficient of 0.9-1.5 ppm/° C., and may replace an invar resonator in the prior art; a resonance tube that is manufactured using powder materials that include iron powder and nickel powder has a linear expansion coefficient of 2.5-3.5 ppm/° C., which is slightly greater than that of an invar resonance tube, and can solve the problem of excessive temperature compensation of the invar resonance tube; and a resonance tube that is manufactured using powder materials that include carbonyl iron powder, carbonyl nickel powder, and carbonyl cobalt powder has a linear expansion coefficient of 4.5-6.0 ppm/° C., which is a medium expansion coefficient, and can address a lack of a resonator with a linear expansion coefficient of 4.5-6.0 ppm/° C. in the prior art.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A resonance tube, wherein the resonance tube is manufactured using powder materials, wherein the powder materials comprise:
at least one of carbonyl iron powder and iron powder; and
at least one of carbonyl nickel powder and nickel powder,
wherein a mass percentage of the at least one of carbonyl iron powder and iron powder in the powder materials is 58-70%, and
wherein a mass percentage of the at least one of carbonyl nickel powder and nickel powder in the powder materials is 30-42%.

2. The resonance tube according to claim 1, wherein granularity distribution of the powder materials for manufacturing the resonance tube comprises:
a mass of a powder material whose granule diameter is less than 2 micrometer (μm) is less than 10%;
a mass of a powder material whose granule diameter is 2-10 μm is greater than 80%; and
a mass of a powder material whose granule diameter is greater than 10 μm is less than 10%.

3. The resonance tube according to claim 1, wherein the powder materials comprise carbonyl iron powder and carbonyl nickel powder.

4. The resonance tube according to claim 3, wherein mass percentages of the carbonyl iron powder and the carbonyl nickel powder in the powder materials are 58-70% and 30-42% respectively.

5. The resonance tube according to claim 1, wherein the powder materials further comprise carbonyl cobalt powder.

6. The resonance tube according to claim 1, wherein a surface of the resonance tube is electroplated with a copper layer.

7. The resonance tube according to claim 6, wherein the surface of the resonance tube is further electroplated with a silver layer.

8. The resonance tube according to claim 7, wherein thickness of the silver layer is 3-5 μm.

9. The resonance tube according to claim 6, wherein thickness of the copper layer is greater than 5 μm.

10. The resonance tube according to claim 9, wherein thickness of the silver layer is 3-5 μm.

11. The resonance tube according to claim 1, wherein a linear expansion coefficient of the resonance tube is 0.9-12 ppm/° C.

12. A method for manufacturing a resonance tube comprising:
performing mixing processing on powder materials;
making powder materials that are obtained after the mixing processing into granules;
performing injection molding on the granules to form a resonance tube blank; and
performing vacuum sintering on the resonance tube blank,
wherein the powder materials comprise at least one of carbonyl iron powder and iron powder and at least one of carbonyl nickel powder and nickel powder,
wherein a mass percentage of the at least one of carbonyl iron powder and iron powder in the powder materials is 58-70%, and
wherein a mass percentage of the at least one of carbonyl nickel powder and nickel powder in the powder materials is 30-42%.

13. The manufacturing method according to claim 12, wherein after performing vacuum sintering on the resonance tube blank, the method further comprises performing electroplating processing on a resonance tube blank that is obtained after the vacuum sintering.

14. The manufacturing method according to claim 12, wherein performing mixing processing on the powder materials comprises mixing the powder materials, and then adding an adhesive for mixing.

15. The manufacturing method according to claim 14, wherein the adhesive comprises polypropylene and paraffin wax.

16. The manufacturing method according to claim 14, wherein mass percentages of the powder materials and the adhesive are 60-90% and 10-40% respectively.

17. The manufacturing method according to claim 12, wherein making powder materials that are obtained after the mixing into granules comprises making the powder materials that are obtained after the mixing processing into bar-shaped or columnar granules.

18. The manufacturing method according to claim 12, wherein making powder materials that are obtained after the mixing processing into granules comprises making the powder materials that are obtained after the mixing processing into granules under an operating temperature of 150-300° C. and an operating pressure of 5-10 mega Pascal (MPa).

19. The manufacturing method according to claim 12, wherein performing injection molding on the granules to form the resonance tube blank comprises performing injection molding on the granules to form the resonance tube blank under an operating temperature of 200-300° C. and an operating pressure of 40-50 MPa.

20. The manufacturing method according to claim 12, wherein performing vacuum sintering on the resonance tube blank comprises performing the vacuum sintering on the resonance tube blank at a sintering temperature of 1300-1350° C.

21. The manufacturing method according to claim 13, wherein performing electroplating processing on the resonance tube blank that is obtained after the vacuum sintering comprises performing copper electroplating and then silver electroplating on the resonance tube blank that is obtained after the vacuum sintering.

22. The manufacturing method according to claim 21, wherein thickness of an electroplated copper layer is greater than 5 μm.

23. The manufacturing method according to claim 22, wherein thickness of an electroplated silver layer is 3-5 μm.

24. The manufacturing method according to claim 21, wherein thickness of an electroplated silver layer is 3-5 μm.

25. A cavity filter comprising:
a tuning apparatus;
a resonance tube; and
a cavity, wherein the resonance tube is manufactured using powder materials, wherein the powder materials comprise at least one of carbonyl iron powder and iron powder and at least one of carbonyl nickel powder and nickel powder, wherein a mass percentage of the at least one of carbonyl iron powder and iron powder in the powder materials is 58-70%, wherein a mass percentage of the at least one of carbonyl nickel powder and nickel powder in the powder materials is 30-42%, wherein an inner cavity is formed inside the resonance tube, and an outer cavity is formed inside the cavity, and wherein the tuning apparatus is located in the inner cavity, and the resonance tube is located in the outer cavity.
